(19) United States
(12) Patent Application Publication
(10) Pub. No.: US 2018/0154662 A1
(43) Pub. Date: Jun. 7, 2018

(54) MEDIA GUIDES FOR USE IN PRINTERS AND METHODS FOR USING THE SAME

(71) Applicant: Datamax-O'Neil Corporation, Orlando, IL (US)

(72) Inventors: Wai Kit Ho, Singapore (SG); Chia Kiang Sum, Singapore (SG)

(21) Appl. No.: 15/367,359

(22) Filed: Dec. 2, 2016

(51) Int. Cl. B41J 15/04; B41J 2/325; B41J 15/02

(52) U.S. Cl. CPC B41J 15/046; B41J 15/02; B41J 2/325

(57) ABSTRACT

A media guide is provided for use in printer. Media guide includes main body portion having internal bore configured to be disposed around media spindle and guide member connected to main body portion. Guide member is configured to extend outwardly from main body portion to extended position and to retract toward main body portion to collapsed position. Method for using media guide is also provided. Media guide is disposed on media spindle such that media spindle extends through internal bore of main body portion and is positioned and locked at selected position along length of media spindle. When media roll is disposed on media spindle, guide member is extended to extended position. When media roll is configured to be one of loaded onto or unloaded from media spindle, guide member is retracted to collapsed position.

### FIELD OF THE INVENTION

The present invention relates to printers and more particularly relates to media guides for use in printers, and methods for using the same.

### BACKGROUND

Conventional barcode printers are normally equipped with a media guide to help control the position of print media supplied from a media supply roll and rewound onto a media rewind roll in an effort to obtain good printing performance during printer operation. The media supply roll comprises print media wound onto a media core. The media rewind roll may be a depleted media supply roll, or an empty media take (i.e., an empty media core).

However, conventional media guides may be too big, obstructing loading and unloading of the media supply roll onto and from a media supply spindle of the printer and/or obstructing loading and unloading of the media rewind roll onto and from a media rewind spindle of the printer. Conventional media guides may alternatively be too small to sufficiently guide (i.e., control the position of) the full media supply roll and/or the full media rewind roll all the way through to depletion. Media guides that are too small may also damage the print media due to physical edge contact as the print media unwinds from the media supply roll.

Therefore, a need exists for media guides for use in printers, and methods for using the same. There is also a need for media guides that permit unobstructed loading and unloading of the media supply roll and/or media rewind roll, achieve good guiding performance, and may be used in printers having limited space.

### SUMMARY

A media guide is provided for use in a printer having a media spindle, according to various embodiments of the present invention. The media guide comprises a main body portion having an internal bore configured to be disposed around the media spindle and a guide member connected to the main body portion. The guide member is configured to extend outwardly from the main body portion to an extended position and to retract toward the main body portion to a collapsed position.

A printer is provided, according to various embodiments of the present invention. The printer comprises a media spindle configured for having a media roll disposed thereon and a media guide. The media guide comprises a main body portion having an internal bore and a guide member connected to the main body portion. The internal bore is configured to be disposed around the media spindle at a position outboard of the media roll. The guide member is configured to be extended outwardly from the main body portion to an extended position and to be retracted toward the main body portion to a collapsed position.

A method is provided for using a media guide in a printer, according to various embodiments of the present invention. The method comprises disposing the media guide on a media spindle and positioning and locking the media guide at a selected position along a length of the media spindle. When the media roll is disposed on the media spindle, the method further comprises extending the guide member to an extended position. When the media roll is configured to be one of loaded onto or unloaded from the media spindle, the method further comprises collapsing the guide member to a collapsed position. The media guide is disposed on the media spindle such that the media spindle extends through an internal bore of a main body portion of the media guide. The main body portion is connected to a guide member of the media guide.

The foregoing illustrative summary, as well as other exemplary objectives and/or advantages of the present invention, and the manner in which the same are accomplished, are further explained within the following detailed description and its accompanying drawings.

### BRIEF DESCRIPTION OF THE DRAWINGS

FIG. 1A graphically illustrates a portion of an exemplary printer in which a media guide may be used according to various embodiments, a cover of the printer removed to illustrate a ribbon supply spindle, a media supply spindle, and a media rewind spindle of the printer;

FIG. 1B schematically depicts components of the printer of FIG. 1A according to various embodiments, illustrating a media supply roll (an exemplary media roll) disposed on the media supply spindle (an exemplary media spindle) and a media rewind roll (an exemplary media roll) disposed on the media rewind spindle (an exemplary media spindle) with a media guide according to various embodiments disposed on the media rewind spindle;

FIG. 1C schematically depicts a print media path as print media from the media supply roll disposed on the media supply spindle unwinds therefrom, travels through the printer, and is rewound onto the media rewind roll disposed on the media rewind spindle, the media guide according to various embodiments illustrated as disposed on the media supply spindle;

FIGS. 2A and 2B are respectively a perspective view and a front view of the media guide of FIGS. 1B and 1C in isolation, according to various embodiments;

FIG. 2C is an enlarged isolation view of the media roll (such as the media rewind roll and/or media supply roll of FIGS. 1B and 1C) and the media guide of FIGS. 2A and 2B disposed on the media spindle (such as the media rewind spindle and/or media supply spindle of FIGS. 1B and 1C), illustrating a guide member of the media guide in a collapsed position for unobstructed loading/unloading of the media roll from the media spindle, according to various embodiments;

FIG. 3 is a similar view to FIG. 2C, illustrating the guide member of the media guide in an extended position for guiding the media roll during operation of the printer, according to various embodiments;

FIGS. 3A and 3B are front views of the media guide in isolation, illustrating extension (FIG. 3A) and retraction (FIG. 3B) of the guide member thereof by rotation of the main body portion of the guide member, according to various embodiments; and

FIG. 4 is a flow diagram of a method for using a media guide in a printer having a media spindle, according to various embodiments.

### DETAILED DESCRIPTION

Various embodiments are directed to media guides for use in printers, and methods for using the same. Various embodiments provide a media guide that permits unobstructed loading and unloading of a media roll, achieves good guiding performance in guiding the media roll, and may be used in printers having limited space. As used herein, a “media roll” comprises a media supply roll and/or a media rewind roll and a “media spindle” comprises a media supply spindle and/or a media rewind spindle.

Various embodiments of the present invention will be described in relation to a thermal transfer barcode printer. As used herein, the term “printer” refers to a device that prints text, barcodes, illustrations, etc. onto the print media (e.g., labels, tickets, plain paper, receipt paper, plastic transparencies, and the like. In the thermal transfer printer, an ink ribbon supplies the media (e.g., ink) that transfers onto the print media. However, the present invention may be equally applicable to other types and styles of printers that may benefit from using a media guide therein (e.g., a direct transfer barcode printer).

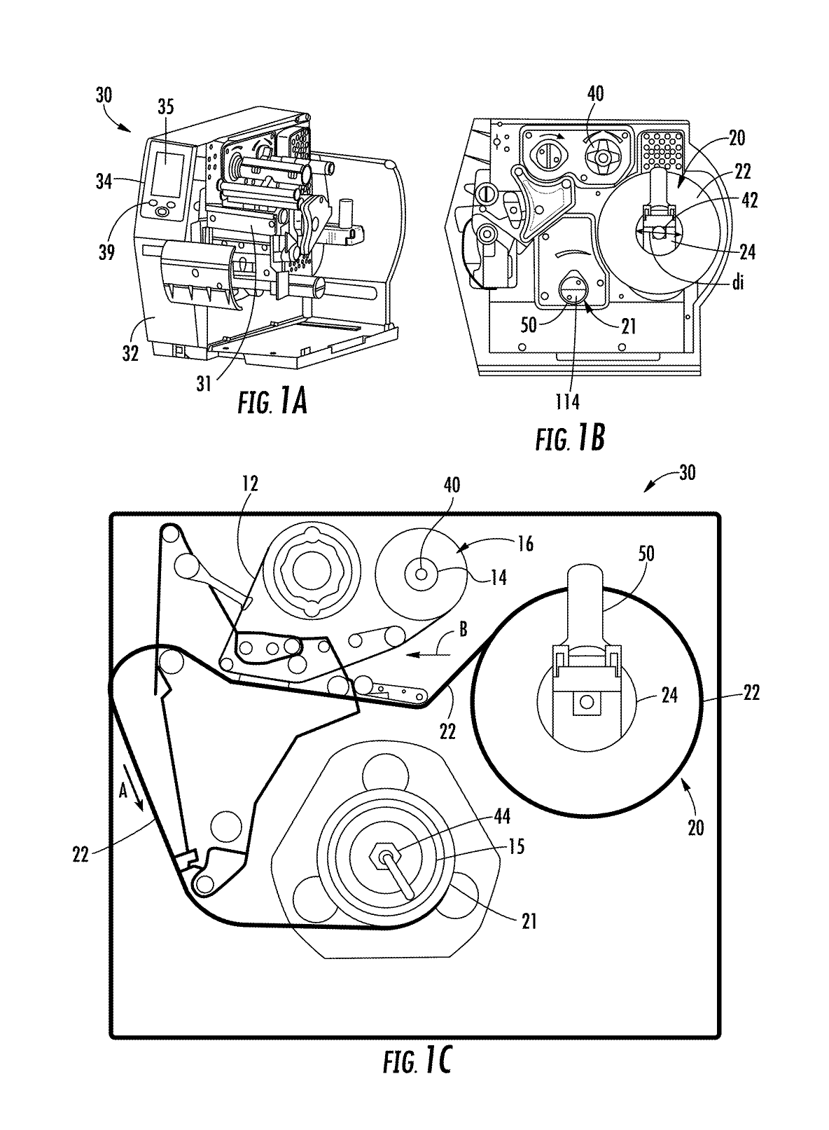

Now referring to FIGS. 1A through 1C, according to various embodiments, an exemplary printer 30 capable of printing on print media 22 and in which a media guide 50 (FIGS. 1B, 1C, and FIGS. 2 through 5) (herein described) may be used is partially shown. The depicted printer 30 has a body including a user interface 34 (FIG. 1) for communication between a user and the printer 30.

In the case of a thermal transfer printer, there may be a ribbon supply spindle 40 contained within the body 32. A ribbon supply roll 16 is configured to be disposed on the ribbon supply spindle 40. The ribbon supply roll 16 comprises ink ribbon 12 wound on a ribbon core 14. As noted previously, in a thermal transfer printer, the ink ribbon supplies the media (e.g., ink) that transfers onto the print media.

The printer 30 may further comprise a thermal print head 31 utilized to thermally transfer a portion of ink from the ink ribbon 12 to the print media 22 as the ink ribbon is unwound from the ribbon supply spool 14 along a ribbon path and the print media 22 is unwound from a media supply spool 24 (also referred to herein as a “media core”) along a media path (arrow A in FIG. 1C) as herein described.

A media supply spindle 42 on which the media supply roll 20 is configured to be disposed is contained within the body 32. A media rewind spindle 44 on which unwound print media 22 is wound up may also be contained within the body 32. A media take 15 may be disposed on the media rewind spindle 44 although the media take 15 on the media rewind spindle 44 may not be necessary. The ribbon take on which the unwound print media is wound up is referred to herein as a “media rewind roll” 21. As previously noted, a “media roll” comprises a media supply roll 20 and/or a media rewind roll 21. While a printer having both a media supply spindle and a media rewind spindle is illustrated, it is to be understood that the printer may have only the media supply spindle. Each of the ribbon supply spindle (if present) and the media rewind spindle is configured to rotate during operation of the printer.

The printer 30 further comprises a power source and a moveable cover (removed in FIG. 1 for purposes of illustration) for accessing the media supply spindle 42, the media rewind spindle 44, etc. contained within the body 32. The printer may further comprise a central processing unit (CPU) (not shown). As known in the art, the central processing unit (CPU) is the electronic circuitry within a computer that carries out the instructions of a computer program by performing the basic arithmetic, logical, control and input/output (I/O) operations specified by the instructions as hereinafter described.

The media supply roll 20 comprises print media 22 wound on the media supply spool 24, the print media 22 and media supply spool 24 collectively referred to as the “media supply roll” 20. The print media 22 may be continuous or non-continuous. The media supply roll 20 has an outer diameter (d) (FIG. 1C) and an inner diameter (di) (FIG. 1B). The outer diameter (d) of the media supply roll decreases as the print media 22 is used for printing. The media supply roll inner diameter (di) is also known as a “media core outer diameter” (i.e., the outer diameter of the media supply spool 24 or media core as depicted in FIG. 1B). As noted previously, the print media 22 may comprise labels, tickets, plain paper, plastic transparencies, and the like.

The media supply roll 20 is disposed onto the media supply spindle 42 and the print media 22 threaded through the printer 30 according to the printer manufacturer's instructions. For example, as depicted in FIG. 1C, a print media leading edge is pulled forward (arrow B) from the media supply roll 20 disposed on the media supply spindle 42, threaded through the printer 30, and attached to the media rewind spindle 44 (with, for example, tape on an empty media take 15). The media rewind spindle 44 is rotated until the print media 22 overlaps the print media leading edge and stretches tight.

The printer 30 may further comprise one or more motors (not shown) for rotating the ribbon supply spindle 40 and the ribbon roll 16 disposed thereon (if present) in a forward or a backward rotational direction (dependent on the ink surface), for rotating the media supply roll 20 disposed on the (fixed) media supply spindle 42 in a forward rotational direction, and for rotating the ribbon rewind spindle 44. The printer 30 may have other components as known in the art.

The user interface 34 (FIG. 1A) may include, but is not limited to, a display 35 for displaying information and function buttons 39 that may be configured to perform various typical printing functions (e.g., cancel print job, advance print media, and the like) or be programmable for the execution of macros containing preset printing parameters for a particular type of print media. The display 35 may include a touch screen keypad for entering data or the keypad may be separate. Additionally, the user interface 34 may be operationally/communicatively coupled to the processor (CPU) (not shown) for controlling the operation of the printer 30, in addition to other functions. The user interface 34 may be supplemented by or replaced by other forms of data entry or printer control such as a separate data entry and control module linked wirelessly or by a data cable operationally coupled to a computer, a router, or the like.

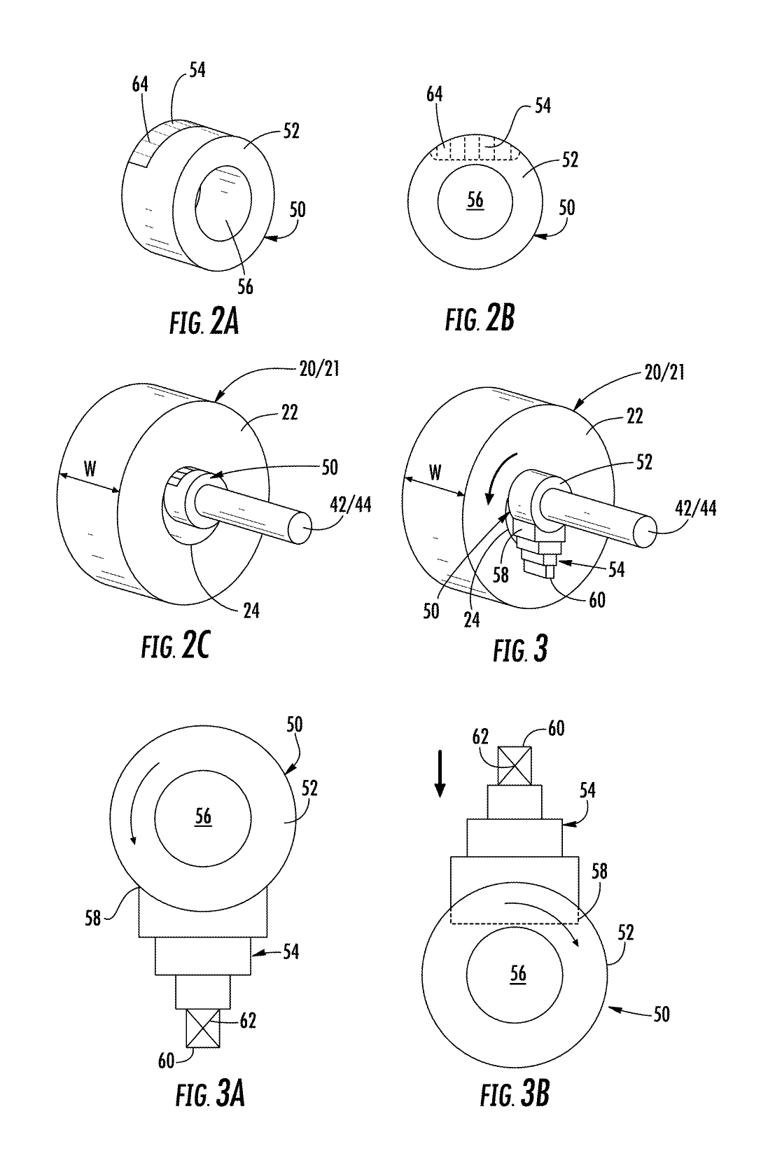

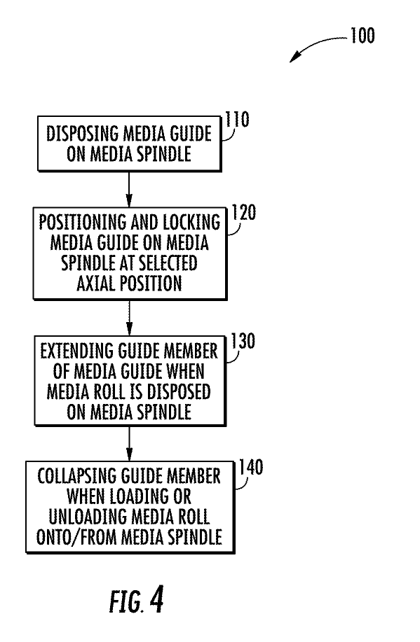

Referring now specifically to FIGS. 2 through 3B, according to various embodiments, the media guide 50 configured for use in a printer (such as the printer 30 depicted in FIGS. 1A through 1C) is depicted. The media guide 50 may be used on at least one of the media supply spindle 42 and the media rewind spindle 44 (as noted previously, referred to collectively herein, unless otherwise specified as a “media spindle”). While FIG. 1B depicts the media guide 50 disposed on the media rewind spindle 44 for guiding the media rewind roll 21 and FIG. 1C depicts the media guide 50 disposed on the media supply spindle 42 for guiding the media supply roll 20, it is to be understood that the media guide may be disposed on one or both (“at least one”) of the media supply spindle and the media rewind spindle. The media guide 50 may be a printer accessory and thus removable from the printer (more particularly, from the media spindle 42/44 of the printer). The media guide 50 may alternatively be an integral part of the media spindle 42/44.

Still referring to FIGS. 2 through 3B, according to various embodiments, the media guide 50 generally comprises a main body portion 52 and a collapsible/extendible guide member 54 connected thereto. The “connected” guide member 54 may be integral with the main body portion 52 (i.e., one-piece) or may be assembled together with the main body portion by mechanical means or the like. The main body portion 52 of the media guide 50 has an internal bore 56 configured to be disposed around the media spindle 42/44 as depicted in FIGS. 2C and 3. The media spindle 42/44 extends through the internal bore 56. The position of the media guide 50 along the length of the media spindle 42/44 is adjustable by sliding the media guide 50 along the length of the media spindle. The media guide 50 may be locked onto the media spindle 42/44 in an operating position (a selected position along the length of the media spindle) where the media guide 50 remains adjacent to and outboard of the media roll. Thus, the selected position depends upon a width (w) (FIGS. 2C and 3) of the media roll. Locking means as known in the art may be used to lock the media guide 50 into the operating position on the media spindle 42/44.

The main body portion 52 may have any shape. The main body portion 52 of the exemplary media guide depicted in FIGS. 2 through 3B has a generally cylindrical shape. The main body portion 52 is dimensioned such that, when the guide member 54 of the media guide 50 is in a collapsed position as hereinafter described and depicted in FIGS. 2 through 2C, the outer diameter of the main body portion 52 is less than the inner diameter of the media core 24, enabling use of the media guide 50 in a printer having limited space within the body 32 thereof and enabling unobstructed loading/unloading of the media roll from the media spindle.

Now referring specifically to FIGS. 3 through 3B, according to various embodiments, the guide member 54 has a first end 58 fixedly coupled to the main body portion 52 and a second free end 60. The second free end 60 may include a weight 62 for purposes as herein described. The guide member 54 has a longitudinal axis that is substantially perpendicular with a longitudinal axis of the internal bore 56. The guide member may itself have any profile. The guide member 54 may be a telescoping guide member.

According to various embodiments and as noted previously, the guide member 54 is configured to be collapsed (FIG. 3B) and to be extended (FIG. 3A) (i.e., the guide member is collapsible (i.e., retractable and extendible). The guide member 54 is configured to be collapsed toward the main body portion 52 to a collapsed position as depicted in FIGS. 2A through 2C and to be extended outwardly from the main body portion 52 to an extended position as depicted in FIGS. 3 and 3A. In the collapsed position, the guide member 54 is retracted into a recess 64 (FIGS. 2A and 2B) in the main body portion 52.

In accordance with various embodiments, FIG. 2C depicts the media guide 50 on the media spindle 42/44 with the guide member 54 in the collapsed position (FIGS. 2A through 2C). As noted previously, the media roll 20/21 may be easily loaded and unloaded onto and from the media spindle 42/44 (e.g., the media supply roll 20 may be unloaded when depleted, in which case, only the media core 24 of the media supply roll 20 may be unloaded). Therefore, the media guide 50 with the guide member 54 in the collapsed position as shown in FIGS. 2A through 2C enables unobstructed loading and unloading of the media roll 20/21 from the media spindle 42/44.

According to various embodiments, the guide member may be extended to the extended position (FIG. 3) by counterclockwise rotation of the main body portion 52 to drop the second free end 60 to a downward position (FIG. 3A) and the guide member may be collapsed/retracted by clockwise 180 degrees rotation of the main body portion 52 to move the guide member 54 to an upright position for free drop down toward the main body portion (FIG. 3B). The guide member 54 may collapse into the recess 64 (FIGS. 2A and 2B) of the main body portion by gravity (free drop down). The guide member 54 may additionally or alternatively be extended and/or retracted by mechanical means. In various embodiments, the user can extend and collapse the guide member regardless of the orientation of the media guide (e.g. the guide member may remain extended by use of a spring, friction, etc. The guide member 54 may be collapsed by the user when the printer is not operating, in order to load or unload the media roll 20/21 from the media spindle 42/44. While counterclockwise rotation to extend and clockwise rotation to retract has been described, it is to be understood that the guide member may be retracted by counterclockwise rotation and extended by clockwise rotation.

Referring again to FIGS. 3 and 3A, according to various embodiments, the media guide 50 with the guide member 54 in the extended position is configured to guide the media roll 20/21 during printer operation. The media guide 50 (more particularly, the guide member 54 thereof) disposed around the media supply spindle 42 guides the media supply roll 20 as the print media 22 unwinds from the media supply roll 20 during printer operation, travels along the media path A (FIG. 1A), and rewinds onto the media rewind roll 21. The media guide 50 disposed around the media rewind spindle 44 may guide the media rewind roll 21 as the print media 22 rewinds onto the media rewind roll.

Still referring to FIG. 3, according to various embodiments, the guide member 54 in the extended position is elongated such that when the media guide 50 is disposed on the media spindle 42/44 with the media roll 20/21, the guide member 54 extends adjacent and along an outboard side of the media roll 20/21, providing an enlarged surface area for better guiding performance relative to conventional media guides that may reach the media core only. The guide member in the extended position has a length according to design requirements and the media roll being used. The length of the guide member 54 in the extended position (the elongated guide member) may be such as to extend substantially to the outer diameter of a full media roll, and even just beyond the outer diameter of a full media roll. In various embodiments, the elongated guide member may be shorter so as to not extend substantially to the outer diameter of a full media roll.

Referring now to FIG. 4, according to various embodiments, a method 100 for using the media guide in a printer (such as printer 30 depicted in FIGS. 1A through 1C) is illustrated. The method 100 for using a media guide in a printer comprises disposing the media guide on the media spindle such that the media spindle extends through the internal bore of the main body portion of the media guide (step 110).

Still referring to FIG. 4, according to various embodiments, the method 100 for using the media guide in a printer comprises positioning and locking the media guide at a selected position along a length of the media spindle (step 120). Positioning and locking the media guide at a selected position comprises positioning and locking the media guide at the selected position that is adjacent to an outboard side of the media roll when disposed on the media spindle.

Still referring to FIG. 4, and again to FIG. 3A, according to various embodiments, the method 100 for using the media guide in the printer comprises extending the guide member to an extended position when the media roll is disposed on the media spindle (step 130). As noted previously, extending the guide member comprises one of rotating the main body portion of the media guide counterclockwise or clockwise until the guide member may freely drop down as a result of gravity as shown in FIG. 3A or by activating a mechanical mechanism, according to various embodiments. As noted previously, the free second end 60 of the guide member 54 may include the weight 62 to assist with the free drop down.

Still referring to FIG. 4, and again to FIG. 3B, according to various embodiments, the method 100 for using the media guide in the printer comprises the method further comprises collapsing the guide member to a collapsed position when the media roll is configured to be one of loaded onto or unloaded from the media spindle (step 140). As noted previously, retracting the (elongated) guide member comprises rotating the main body portion 52 of the media guide clockwise or counterclockwise (the opposite direction of rotation to extend the guide member) the about 180 degrees from when the guide member is in the extended position. FIG. 3B depicts clockwise rotation of the main body portion 52 to collapse the guide member 54 toward the main body portion 52. The guide member 54 may collapse into the recess 64 (FIGS. 2A and 2B) of the main body portion 52 by gravity (free drop down). While step 140 is depicted in FIG. 4 as being performed after step 130, it is to be understood that step 140 may be performed prior to step 130 if loading the media roll onto the media spindle.

The guide member 54 may be collapsed by the user when the printer is not operating, in order to load or unload the media roll from the media spindle. The guide member is extended to the extended position by counterclockwise rotation of the main body portion to drop the second free end to a downward position and the guide member is retracted by clockwise rotation of the main body portion to move the guide member to an upright position for free drop down toward the main body portion. As noted previously, while counterclockwise rotation to extend and clockwise rotation to retract has been described, it is to be understood that the guide member may be retracted by counterclockwise rotation and extended by clockwise rotation. The rotation direction to extend is opposite the rotation direction to retract.

From the foregoing, it is to be appreciated that a media guide according to various embodiments permits unobstructed loading and unloading of a media roll (a media supply roll and/or a media rewind roll), provides good guiding performance, and may be used in printers having limited space.

To supplement the present disclosure, this application incorporates entirely by reference the following commonly assigned patents, patent application publications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,525;
U.S. Pat. No. 8,794,526; U.S. Pat. No. 8,798,367;
U.S. Pat. No. 8,807,431; U.S. Pat. No. 8,807,432;
U.S. Pat. No. 8,820,630; U.S. Pat. No. 8,822,848;
U.S. Pat. No. 8,824,692; U.S. Pat. No. 8,824,696;
U.S. Pat. No. 8,842,849; U.S. Pat. No. 8,844,822;
U.S. Pat. No. 8,844,823; U.S. Pat. No. 8,849,019;
U.S. Pat. No. 8,851,383; U.S. Pat. No. 8,854,633;
U.S. Pat. No. 8,866,963; U.S. Pat. No. 8,868,421;
U.S. Pat. No. 8,868,519; U.S. Pat. No. 8,868,802;
U.S. Pat. No. 8,868,803; U.S. Pat. No. 8,870,074;
U.S. Pat. No. 8,879,639; U.S. Pat. No. 8,880,426;
U.S. Pat. No. 8,881,983; U.S. Pat. No. 8,881,987;
U.S. Pat. No. 8,903,172; U.S. Pat. No. 8,908,995;
U.S. Pat. No. 8,910,870; U.S. Pat. No. 8,910,875;
U.S. Pat. No. 8,914,290; U.S. Pat. No. 8,914,788;
U.S. Pat. No. 8,915,439; U.S. Pat. No. 8,915,444;
U.S. Pat. No. 8,916,789; U.S. Pat. No. 8,918,250;
U.S. Pat. No. 8,918,564; U.S. Pat. No. 8,925,818;
U.S. Pat. No. 8,939,374; U.S. Pat. No. 8,942,480;
U.S. Pat. No. 8,944,313; U.S. Pat. No. 8,944,327;
U.S. Pat. No. 8,944,332; U.S. Pat. No. 8,950,678;
U.S. Pat. No. 8,967,468; U.S. Pat. No. 8,971,346;
U.S. Pat. No. 8,976,030; U.S. Pat. No. 8,976,368;
U.S. Pat. No. 8,978,981; U.S. Pat. No. 8,978,983;
U.S. Pat. No. 8,978,984; U.S. Pat. No. 8,985,456;
U.S. Pat. No. 8,985,457; U.S. Pat. No. 8,985,459;
U.S. Pat. No. 8,985,461; U.S. Pat. No. 8,988,578;
U.S. Pat. No. 8,988,590; U.S. Pat. No. 8,991,704;
U.S. Pat. No. 8,996,194; U.S. Pat. No. 8,996,384;
U.S. Pat. No. 9,002,641; U.S. Pat. No. 9,007,368;
U.S. Pat. No. 9,010,641; U.S. Pat. No. 9,015,513;
U.S. Pat. No. 9,016,576; U.S. Pat. No. 9,022,288;
U.S. Pat. No. 9,030,964; U.S. Pat. No. 9,033,240;
U.S. Pat. No. 9,033,242; U.S. Pat. No. 9,036,054;
U.S. Pat. No. 9,037,344; U.S. Pat. No. 9,038,911;
U.S. Pat. No. 9,038,915; U.S. Pat. No. 9,047,098;
U.S. Pat. No. 9,047,359; U.S. Pat. No. 9,047,420;
U.S. Pat. No. 9,047,525; U.S. Pat. No. 9,047,531;
U.S. Pat. No. 9,053,055; U.S. Pat. No. 9,053,378;
U.S. Pat. No. 9,053,380; U.S. Pat. No. 9,058,526;
U.S. Pat. No. 9,064,165; U.S. Pat. No. 9,064,167;
U.S. Pat. No. 9,064,168; U.S. Pat. No. 9,064,254;
U.S. Pat. No. 9,066,032; U.S. Pat. No. 9,070,032;
U.S. Design Pat. No. D716,285;
U.S. Design Pat. No. D723,560;
U.S. Design Pat. No. D730,357;
U.S. Design Pat. No. D730,901;
U.S. Design Pat. No. D730,902;
U.S. Design Pat. No. D733,112;
U.S. Design Pat. No. D734,339;
International Publication No. 2013/163789;
International Publication No. 2013/173985;
International Publication No. 2014/019130;
International Publication No. 2014/110495;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2010/0265880;
U.S. Patent Application Publication No. 2011/0202554;
U.S. Patent Application Publication No. 2012/0111946;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0287258;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0342717;
U.S. Patent Application Publication No. 2014/0001267;
U.S. Patent Application Publication No. 2014/0008439;
U.S. Patent Application Publication No. 2014/0025584;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0076974;
U.S. Patent Application Publication No. 2014/0078341;
U.S. Patent Application Publication No. 2014/0078345;
U.S. Patent Application Publication No. 2014/0097249;
U.S. Patent Application Publication No. 2014/0098792;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131438;
U.S. Patent Application Publication No. 2014/0131441;
U.S. Patent Application Publication No. 2014/0131443;
U.S. Patent Application Publication No. 2014/0131444;
U.S. Patent Application Publication No. 2014/0131445;
U.S. Patent Application Publication No. 2014/0131448;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0151453;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0166755;
U.S. Patent Application Publication No. 2014/0166759;
U.S. Patent Application Publication No. 2014/0168787;
U.S. Patent Application Publication No. 2014/0175165;
U.S. Patent Application Publication No. 2014/0175172;
U.S. Patent Application Publication No. 2014/0191644;
U.S. Patent Application Publication No. 2014/0191913;
U.S. Patent Application Publication No. 2014/0197238;
U.S. Patent Application Publication No. 2014/0197239;
U.S. Patent Application Publication No. 2014/0197304;
U.S. Patent Application Publication No. 2014/0214631;
U.S. Patent Application Publication No. 2014/0217166;
U.S. Patent Application Publication No. 2014/0217180;
U.S. Patent Application Publication No. 2014/0231500;
U.S. Patent Application Publication No. 2014/0232930;
U.S. Patent Application Publication No. 2014/0247315;
U.S. Patent Application Publication No. 2014/0263493;
U.S. Patent Application Publication No. 2014/0263645;
U.S. Patent Application Publication No. 2014/0267609;
U.S. Patent Application Publication No. 2014/0270196;
U.S. Patent Application Publication No. 2014/0270229;
U.S. Patent Application Publication No. 2014/0278387;
U.S. Patent Application Publication No. 2014/0278391;
U.S. Patent Application Publication No. 2014/0282210;
U.S. Patent Application Publication No. 2014/0284384;
U.S. Patent Application Publication No. 2014/0288933;
U.S. Patent Application Publication No. 2014/0297058;
U.S. Patent Application Publication No. 2014/0299665;
U.S. Patent Application Publication No. 2014/0312121;
U.S. Patent Application Publication No. 2014/0319220;
U.S. Patent Application Publication No. 2014/0319221;
U.S. Patent Application Publication No. 2014/0326787;
U.S. Patent Application Publication No. 2014/0332590;
U.S. Patent Application Publication No. 2014/0344943;
U.S. Patent Application Publication No. 2014/0346233;
U.S. Patent Application Publication No. 2014/0351317;
U.S. Patent Application Publication No. 2014/0353373;
U.S. Patent Application Publication No. 2014/0361073;
U.S. Patent Application Publication No. 2014/0361082;
U.S. Patent Application Publication No. 2014/0362184;
U.S. Patent Application Publication No. 2014/0363015;
U.S. Patent Application Publication No. 2014/0369511;
U.S. Patent Application Publication No. 2014/0374483;
U.S. Patent Application Publication No. 2014/0374485;
U.S. Patent Application Publication No. 2015/0001301;
U.S. Patent Application Publication No. 2015/0001304;
U.S. Patent Application Publication No. 2015/0003673;
U.S. Patent Application Publication No. 2015/0009338;
U.S. Patent Application Publication No. 2015/0009610;
U.S. Patent Application Publication No. 2015/0014416;
U.S. Patent Application Publication No. 2015/0021397;
U.S. Patent Application Publication No. 2015/0028102;
U.S. Patent Application Publication No. 2015/0028103;
U.S. Patent Application Publication No. 2015/0028104;
U.S. Patent Application Publication No. 2015/0029002;
U.S. Patent Application Publication No. 2015/0032709;
U.S. Patent Application Publication No. 2015/0039309;
U.S. Patent Application Publication No. 2015/0039878;
U.S. Patent Application Publication No. 2015/0040378;
U.S. Patent Application Publication No. 2015/0048168;
U.S. Patent Application Publication No. 2015/0049347;
U.S. Patent Application Publication No. 2015/0051992;
U.S. Patent Application Publication No. 2015/0053766;
U.S. Patent Application Publication No. 2015/0053768;
U.S. Patent Application Publication No. 2015/0053769;
U.S. Patent Application Publication No. 2015/0060544;
U.S. Patent Application Publication No. 2015/0062366;
U.S. Patent Application Publication No. 2015/0063215;
U.S. Patent Application Publication No. 2015/0063676;
U.S. Patent Application Publication No. 2015/0069130;
U.S. Patent Application Publication No. 2015/0071819;
U.S. Patent Application Publication No. 2015/0083800;
U.S. Patent Application Publication No. 2015/0086114;
U.S. Patent Application Publication No. 2015/0088522;
U.S. Patent Application Publication No. 2015/0096872;
U.S. Patent Application Publication No. 2015/0099557;
U.S. Patent Application Publication No. 2015/0100196;
U.S. Patent Application Publication No. 2015/0102109;
U.S. Patent Application Publication No. 2015/0115035;
U.S. Patent Application Publication No. 2015/0127791;
U.S. Patent Application Publication No. 2015/0128116;
U.S. Patent Application Publication No. 2015/0129659;
U.S. Patent Application Publication No. 2015/0133047;
U.S. Patent Application Publication No. 2015/0134470;
U.S. Patent Application Publication No. 2015/0136851;
U.S. Patent Application Publication No. 2015/0136854;
U.S. Patent Application Publication No. 2015/0142492;
U.S. Patent Application Publication No. 2015/0144692;
U.S. Patent Application Publication No. 2015/0144698;
U.S. Patent Application Publication No. 2015/0144701;
U.S. Patent Application Publication No. 2015/0149946;
U.S. Patent Application Publication No. 2015/0161429;
U.S. Patent Application Publication No. 2015/0169925;
U.S. Patent Application Publication No. 2015/0169929;
U.S. Patent Application Publication No. 2015/0178523;
U.S. Patent Application Publication No. 2015/0178534;
U.S. Patent Application Publication No. 2015/0178535;
U.S. Patent Application Publication No. 2015/0178536;
U.S. Patent Application Publication No. 2015/0178537;
U.S. Patent Application Publication No. 2015/0181093;
U.S. Patent Application Publication No. 2015/0181109;
U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application Ser. No. 29/458,405 for an Electronic Device, filed Jun. 19, 2013 (Fitch et al.);
U.S. patent application Ser. No. 29/459,620 for an Electronic Device Enclosure, filed Jul. 2, 2013 (London et al.);
U.S. patent application Ser. No. 29/468,118 for an Electronic Device Case, filed Sep. 26, 2013 (Oberpriller et al.);
U.S. patent application Ser. No. 14/150,393 for Indicia-reader Having Unitary Construction Scanner, filed Jan. 8, 2014 (Colavito et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 29/486,759 for an Imaging Terminal, filed Apr. 2, 2014 (Oberpriller et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/334,934 for a SYSTEM AND METHOD FOR INDICIA VERIFICATION, filed Jul. 18, 2014 (Hejl);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/483,056 for VARIABLE DEPTH OF FIELD BARCODE SCANNER filed Sep. 10, 2014 (McCloskey et al.);
U.S. patent application Ser. No. 14/513,808 for IDENTIFYING INVENTORY ITEMS IN A STORAGE FACILITY filed Oct. 14, 2014 (Singel et al.);
U.S. patent application Ser. No. 14/519,195 for HANDHELD DIMENSIONING SYSTEM WITH FEEDBACK filed Oct. 21, 2014 (Laffargue et al.);
U.S. patent application Ser. No. 14/519,179 for DIMENSIONING SYSTEM WITH MULTIPATH INTERFERENCE MITIGATION filed Oct. 21, 2014 (Thuries et al.);
U.S. patent application Ser. No. 14/519,211 for SYSTEM AND METHOD FOR DIMENSIONING filed Oct. 21, 2014 (Ackley et al.);
U.S. patent application Ser. No. 14/519,233 for HANDHELD DIMENSIONER WITH DATA-QUALITY INDICATION filed Oct. 21, 2014 (Laffargue et al.);
U.S. patent application Ser. No. 14/519,249 for HANDHELD DIMENSIONING SYSTEM WITH MEASUREMENT-CONFORMANCE FEEDBACK filed Oct. 21, 2014 (Ackley et al.);
U.S. patent application Ser. No. 14/527,191 for METHOD AND SYSTEM FOR RECOGNIZING SPEECH USING WILDCARDS IN AN EXPECTED RESPONSE filed Oct. 29, 2014 (Braho et al.);
U.S. patent application Ser. No. 14/529,563 for ADAPTABLE INTERFACE FOR A MOBILE COMPUTING DEVICE filed Oct. 31, 2014 (Schoon et al.);
U.S. patent application Ser. No. 14/529,857 for BARCODE READER WITH SECURITY FEATURES filed Oct. 31, 2014 (Todeschini et al.);
U.S. patent application Ser. No. 14/398,542 for PORTABLE ELECTRONIC DEVICES HAVING A SEPARATE LOCATION TRIGGER UNIT FOR USE IN CONTROLLING AN APPLICATION UNIT filed Nov. 3, 2014 (Bian et al.);
U.S. patent application Ser. No. 14/531,154 for DIRECTING AN INSPECTOR THROUGH AN INSPECTION filed Nov. 3, 2014 (Miller et al.);
U.S. patent application Ser. No. 14/533,319 for BARCODE SCANNING SYSTEM USING WEARABLE DEVICE WITH EMBEDDED CAMERA filed Nov. 5, 2014 (Todeschini);
U.S. patent application Ser. No. 14/535,764 for CONCATENATED EXPECTED RESPONSES FOR SPEECH RECOGNITION filed Nov. 7, 2014 (Braho et al.);
U.S. patent application Ser. No. 14/568,305 for AUTO-CONTRAST VIEWFINDER FOR AN INDICIA READER filed Dec. 12, 2014 (Todeschini);
U.S. patent application Ser. No. 14/573,022 for DYNAMIC DIAGNOSTIC INDICATOR GENERATION filed Dec. 17, 2014 (Goldsmith);
U.S. patent application Ser. No. 14/578,627 for SAFETY SYSTEM AND METHOD filed Dec. 22, 2014 (Ackley et al.);
U.S. patent application Ser. No. 14/580,262 for MEDIA GATE FOR THERMAL TRANSFER PRINTERS filed Dec. 23, 2014 (Bowles);
U.S. patent application Ser. No. 14/590,024 for SHELVING AND PACKAGE LOCATING SYSTEMS FOR DELIVERY VEHICLES filed Jan. 6, 2015 (Payne);
U.S. patent application Ser. No. 14/596,757 for SYSTEM AND METHOD FOR DETECTING BARCODE PRINTING ERRORS filed Jan. 14, 2015 (Ackley);
U.S. patent application Ser. No. 14/416,147 for OPTICAL READING APPARATUS HAVING VARIABLE SETTINGS filed Jan. 21, 2015 (Chen et al.);
U.S. patent application Ser. No. 14/614,706 for DEVICE FOR SUPPORTING AN ELECTRONIC TOOL ON A USER'S HAND filed Feb. 5, 2015 (Oberpriller et al.);
U.S. patent application Ser. No. 14/614,796 for CARGO APPORTIONMENT TECHNIQUES filed Feb. 5, 2015 (Morton et al.);
U.S. patent application Ser. No. 29/516,892 for TABLE COMPUTER filed Feb. 6, 2015 (Bidwell et al.);
U.S. patent application Ser. No. 14/619,093 for METHODS FOR TRAINING A SPEECH RECOGNITION SYSTEM filed Feb. 11, 2015 (Pecorari);
U.S. patent application Ser. No. 14/628,708 for DEVICE, SYSTEM, AND METHOD FOR DETERMINING THE STATUS OF CHECKOUT LANES filed Feb. 23, 2015 (Todeschini);
U.S. patent application Ser. No. 14/630,841 for TERMINAL INCLUDING IMAGING ASSEMBLY filed Feb. 25, 2015 (Gomez et al.);
U.S. patent application Ser. No. 14/635,346 for SYSTEM AND METHOD FOR RELIABLE STORE-AND-FORWARD DATA HANDLING BY ENCODED INFORMATION READING TERMINALS filed Mar. 2, 2015 (Sevier);
U.S. patent application Ser. No. 29/519,017 for SCANNER filed Mar. 2, 2015 (Zhou et al.);
U.S. patent application Ser. No. 14/405,278 for DESIGN PATTERN FOR SECURE STORE filed Mar. 9, 2015 (Zhu et al.);
U.S. patent application Ser. No. 14/660,970 for DECODABLE INDICIA READING TERMINAL WITH COMBINED ILLUMINATION filed Mar. 18, 2015 (Kearney et al.);
U.S. patent application Ser. No. 14/661,013 for REPROGRAMMING SYSTEM AND METHOD FOR DEVICES INCLUDING PROGRAMMING SYMBOL filed Mar. 18, 2015 (Soule et al.);
U.S. patent application Ser. No. 14/662,922 for MULTIFUNCTION POINT OF SALE SYSTEM filed Mar. 19, 2015 (Van Horn et al.);
U.S. patent application Ser. No. 14/663,638 for VEHICLE MOUNT COMPUTER WITH CONFIGURABLE IGNITION SWITCH BEHAVIOR filed Mar. 20, 2015 (Davis et al.);
U.S. patent application Ser. No. 14/664,063 for METHOD AND APPLICATION FOR SCANNING A BARCODE WITH A SMART DEVICE WHILE CONTINUOUSLY RUNNING AND DISPLAYING AN APPLICATION ON THE SMART DEVICE DISPLAY filed Mar. 20, 2015 (Todeschini);
U.S. patent application Ser. No. 14/669,280 for TRANSFORMING COMPONENTS OF A WEB PAGE TO VOICE PROMPTS filed Mar. 26, 2015 (Funyak et al.);
U.S. patent application Ser. No. 14/674,329 for AIMER FOR BARCODE SCANNING filed Mar. 31, 2015 (Bidwell);
U.S. patent application Ser. No. 14/676,109 for INDICIA READER filed Apr. 1, 2015 (Huck);
U.S. patent application Ser. No. 14/676,327 for DEVICE MANAGEMENT PROXY FOR SECURE DEVICES filed Apr. 1, 2015 (Yeakley et al.);

U.S. patent application Ser. No. 14/676,898 for NAVIGATION SYSTEM CONFIGURED TO INTEGRATE MOTION SENSING DEVICE INPUTS filed Apr. 2, 2015 (Showering);
U.S. patent application Ser. No. 14/679,275 for DIMENSIONING SYSTEM CALIBRATION SYSTEMS AND METHODS filed Apr. 6, 2015 (Laffargue et al.);
U.S. patent application Ser. No. 29/523,098 for HANDLE FOR A TABLET COMPUTER filed Apr. 7, 2015 (Bidwell et al.);
U.S. patent application Ser. No. 14/682,615 for SYSTEM AND METHOD FOR POWER MANAGEMENT OF MOBILE DEVICES filed Apr. 9, 2015 (Murawski et al.);
U.S. patent application Ser. No. 14/686,822 for MULTIPLE PLATFORM SUPPORT SYSTEM AND METHOD filed Apr. 15, 2015 (Qu et al.);
U.S. patent application Ser. No. 14/687,289 for SYSTEM FOR COMMUNICATION VIA A PERIPHERAL HUB filed Apr. 15, 2015 (Kohtz et al.);
U.S. patent application Ser. No. 29/524,186 for SCANNER filed Apr. 17, 2015 (Zhou et al.);
U.S. patent application Ser. No. 14/695,364 for MEDICATION MANAGEMENT SYSTEM filed Apr. 24, 2015 (Sewell et al.);
U.S. patent application Ser. No. 14/695,923 for SECURE UNATTENDED NETWORK AUTHENTICATION filed Apr. 24, 2015 (Kubler et al.);
U.S. patent application Ser. No. 29/525,068 for TABLET COMPUTER WITH REMOVABLE SCANNING DEVICE filed Apr. 27, 2015 (Schulte et al.);
U.S. patent application Ser. No. 14/699,436 for SYMBOL READING SYSTEM HAVING PREDICTIVE DIAGNOSTICS filed Apr. 29, 2015 (Nahill et al.);
U.S. patent application Ser. No. 14/702,110 for SYSTEM AND METHOD FOR REGULATING BARCODE DATA INJECTION INTO A RUNNING APPLICATION ON A SMART DEVICE filed May 1, 2015 (Todeschini et al.);
U.S. patent application Ser. No. 14/702,979 for TRACKING BATTERY CONDITIONS filed May 4, 2015 (Young et al.);
U.S. patent application Ser. No. 14/704,050 for INTERMEDIATE LINEAR POSITIONING filed May 5, 2015 (Charpentier et al.);
U.S. patent application Ser. No. 14/705,012 for HANDS-FREE HUMAN MACHINE INTERFACE RESPONSIVE TO A DRIVER OF A VEHICLE filed May 6, 2015 (Fitch et al.);
U.S. patent application Ser. No. 14/705,407 for METHOD AND SYSTEM TO PROTECT SOFTWARE-BASED NETWORK-CONNECTED DEVICES FROM ADVANCED PERSISTENT THREAT filed May 6, 2015 (Hussey et al.);
U.S. patent application Ser. No. 14/707,037 for SYSTEM AND METHOD FOR DISPLAY OF INFORMATION USING A VEHICLE-MOUNT COMPUTER filed May 8, 2015 (Chamberlin);
U.S. patent application Ser. No. 14/707,123 for APPLICATION INDEPENDENT DEX/UCS INTERFACE filed May 8, 2015 (Pape);
U.S. patent application Ser. No. 14/707,492 for METHOD AND APPARATUS FOR READING OPTICAL INDICIA USING A PLURALITY OF DATA SOURCES filed May 8, 2015 (Smith et al.);
U.S. patent application Ser. No. 14/710,666 for PRE-PAID USAGE SYSTEM FOR ENCODED INFORMATION READING TERMINALS filed May 13, 2015 (Smith);
U.S. patent application Ser. No. 29/526,918 for CHARGING BASE filed May 14, 2015 (Fitch et al.);
U.S. patent application Ser. No. 14/715,672 for AUGUMENTED REALITY ENABLED HAZARD DISPLAY filed May 19, 2015 (Venkatesha et al.);
U.S. patent application Ser. No. 14/715,916 for EVALUATING IMAGE VALUES filed May 19, 2015 (Ackley);
U.S. patent application Ser. No. 14/722,608 for INTERACTIVE USER INTERFACE FOR CAPTURING A DOCUMENT IN AN IMAGE SIGNAL filed May 27, 2015 (Showering et al.);
U.S. patent application Ser. No. 29/528,165 for IN-COUNTER BARCODE SCANNER filed May 27, 2015 (Oberpriller et al.);
U.S. patent application Ser. No. 14/724,134 for ELECTRONIC DEVICE WITH WIRELESS PATH SELECTION CAPABILITY filed May 28, 2015 (Wang et al.);
U.S. patent application Ser. No. 14/724,849 for METHOD OF PROGRAMMING THE DEFAULT CABLE INTERFACE SOFTWARE IN AN INDICIA READING DEVICE filed May 29, 2015 (Barten);
U.S. patent application Ser. No. 14/724,908 for IMAGING APPARATUS HAVING IMAGING ASSEMBLY filed May 29, 2015 (Barber et al.);
U.S. patent application Ser. No. 14/725,352 for APPARATUS AND METHODS FOR MONITORING ONE OR MORE PORTABLE DATA TERMINALS (Caballero et al.);
U.S. patent application Ser. No. 29/528,590 for ELECTRONIC DEVICE filed May 29, 2015 (Fitch et al.);
U.S. patent application Ser. No. 29/528,890 for MOBILE COMPUTER HOUSING filed Jun. 2, 2015 (Fitch et al.);
U.S. patent application Ser. No. 14/728,397 for DEVICE MANAGEMENT USING VIRTUAL INTERFACES CROSS-REFERENCE TO RELATED APPLICATIONS filed Jun. 2, 2015 (Caballero);
U.S. patent application Ser. No. 14/732,870 for DATA COLLECTION MODULE AND SYSTEM filed Jun. 8, 2015 (Powilleit);
U.S. patent application Ser. No. 29/529,441 for INDICIA READING DEVICE filed Jun. 8, 2015 (Zhou et al.);
U.S. patent application Ser. No. 14/735,717 for INDICIA-READING SYSTEMS HAVING AN INTERFACE WITH A USER'S NERVOUS SYSTEM filed Jun. 10, 2015 (Todeschini);
U.S. patent application Ser. No. 14/738,038 for METHOD OF AND SYSTEM FOR DETECTING OBJECT WEIGHING INTERFERENCES filed Jun. 12, 2015 (Amundsen et al.);
U.S. patent application Ser. No. 14/740,320 for TACTILE SWITCH FOR A MOBILE ELECTRONIC DEVICE filed Jun. 16, 2015 (Bandringa);
U.S. patent application Ser. No. 14/740,373 for CALIBRATING A VOLUME DIMENSIONER filed Jun. 16, 2015 (Ackley et al.);
U.S. patent application Ser. No. 14/742,818 for INDICIA READING SYSTEM EMPLOYING DIGITAL GAIN CONTROL filed Jun. 18, 2015 (Xian et al.);
U.S. patent application Ser. No. 14/743,257 for WIRELESS MESH POINT PORTABLE DATA TERMINAL filed Jun. 18, 2015 (Wang et al.);
U.S. patent application Ser. No. 29/530,600 for CYCLONE filed Jun. 18, 2015 (Vargo et al);
U.S. patent application Ser. No. 14/744,633 for IMAGING APPARATUS COMPRISING IMAGE SENSOR ARRAY HAVING SHARED GLOBAL SHUTTER CIRCUITRY filed Jun. 19, 2015 (Wang);
U.S. patent application Ser. No. 14/744,836 for CLOUD-BASED SYSTEM FOR READING OF DECODABLE INDICIA filed Jun. 19, 2015 (Todeschini et al.);
U.S. patent application Ser. No. 14/745,006 for SELECTIVE OUTPUT OF DECODED MESSAGE DATA filed Jun. 19, 2015 (Todeschini et al.);
U.S. patent application Ser. No. 14/747,197 for OPTICAL PATTERN PROJECTOR filed Jun. 23, 2015 (Thuries et al.);
U.S. patent application Ser. No. 14/747,490 for DUAL-PROJECTOR THREE-DIMENSIONAL SCANNER filed Jun. 23, 2015 (Jovanovski et al.); and
U.S. patent application Ser. No. 14/748,446 for CORDLESS INDICIA READER WITH A MULTIFUNCTION COIL FOR WIRELESS CHARGING AND EAS DEACTIVATION, filed Jun. 24, 2015 (Xie et al.).

In the specification and/or figures, typical embodiments of the present invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A media guide for use in a printer, the media guide comprising:
a main body portion having an internal bore configured to be disposed around a media spindle; and
a guide member connected to the main body portion and configured to telescopically extend outwardly from the main body portion to an extended position and retract toward the main body portion to a collapsed position.

2. (canceled)

3. The media guide according to claim 1, wherein the guide member is configured to retract into a recess in the main body portion.

4. The media guide according to claim 1, wherein the guide member has a first end connected to the main body portion and a second free end.

5. The media guide according to claim 4, wherein the guide member is extended to the extended position by rotation of the main body portion in a first direction to drop the second free end to a downward position.

6. The media guide according to claim 5, wherein the guide member is retracted by rotation of the main body portion in an opposite second direction to move the guide member to an upright position for free drop down toward the main body portion.

7. The media guide according to claim 1, wherein the guide member has a longitudinal axis that is substantially perpendicular with a longitudinal axis of the internal bore.

8. The media guide according to claim 1, wherein the guide member is integrally formed as one piece with the main body portion.

9. The media guide according to claim 1, wherein the main body portion is configured to be disposed around the media spindle at a selected position along a length thereof, the selected position dependent upon a width (w) of the media roll.

10. The media guide according to claim 1, wherein an outer diameter of the main body portion is less than an inner diameter of a media core when the guide member is in the collapsed position.

11. A printer comprising:
a media spindle configured for having a media roll disposed thereon; and
a media guide comprising:
a main body portion having an internal bore configured to be disposed around the media spindle at a position outboard of the media roll; and
a guide member connected to the main body portion and configured to be telescopically extended outwardly from the main body portion to an extended position and to be telescopically retracted toward the main body portion to a collapsed position.

12. The printer according to claim 11, wherein the media spindle comprises at least one of a media supply spindle and a media rewind spindle and the media roll comprises at least one of a media supply roll and a media rewind roll, the media supply spindle configured for having the media supply roll disposed thereon and the media rewind spindle configured for having the media rewind roll disposed thereon.

13. The printer according to claim 11, wherein the guide member is configured to retract into a recess in the main body portion.

14. The printer according to claim 11, wherein the guide member has a first end connected to the main body portion and a second free end.

15. The printer according to claim 14, wherein the guide member is extended to the extended position by rotation of the main body portion in a first direction to drop the second free end to a downward position.

16. The printer according to claim 15, wherein the guide member is retracted by rotation of the main body portion in an opposite second direction to move the guide member to an upright position for free drop down toward the main body portion.

17. The printer according to claim 11, wherein the guide member has a longitudinal axis that is substantially perpendicular with a longitudinal axis of the internal bore.

18. The printer according to claim 11, wherein the main body portion is configured to be disposed around the media spindle at a position along a length thereof, the position dependent upon a width (w) of the media roll.

19. The media guide according to claim 11, wherein an outer diameter of the main body portion is less than an inner diameter of a media core when the guide member is in the collapsed position.

20. A method for using a media guide in a printer, the method comprising:
disposing the media guide on a media spindle such that the media spindle extends through an internal bore of a main body portion of the media guide, the main body portion connected to a guide member of the media guide;
positioning and locking the media guide at a selected position along a length of the media spindle; and
wherein when the media roll is disposed on the media spindle, the method further comprises telescopically extending the guide member to an extended position;
wherein when the media roll is configured to be one of loaded onto or unloaded from the media spindle, the method further comprises telescopically collapsing the guide member to a collapsed position.

21. The method according to claim 20, wherein positioning and locking the media guide at a selected position comprises positioning and locking the media guide at the selected position that is adjacent to an outboard side of the media roll when disposed on the media spindle.

22. The method according to claim 20, wherein extending the guide member to the extended position comprises rotating the main body portion to position the guide member downwardly causing the guide member to drop down away from the main body portion by gravity.

23. The method according to claim 20, wherein collapsing the guide member to the collapsed position comprises rotating the main body portion to position the guide member upwardly causing the guide member to collapse toward the main body portion by gravity.
